(19) United States
(12) Patent Application Publication
(10) Pub. No.: US 2003/0179232 A1
(43) Pub. Date: Sep. 25, 2003

(54) Custom drawing symbols

(76) Inventors: Daniel P. Fousek, Sammamish, WA (US); Bradley N. Wyckhouse, Chesterfield, MO (US); Betty Sung Huang, Irvine, CA (US); James Darrow Linder, Placentia, CA (US)

Correspondence Address: FISH & RICHARDSON P.C., 1425 K STREET, N.W., 11TH FLOOR, WASHINGTON, DC, 20005-3500, US

(21) Appl. No.: 10/104,045

(22) Filed: Mar. 25, 2002

(51) Int. Cl. G09G 5/00

(52) U.S. Cl. 345/762

(57) ABSTRACT

Custom drawing symbols may be created that include geometric data and several notes and different data types for notes. The geometric data may be created using a broad range of features of a computer-aided drawing system. A user interface to create an instance of a custom drawing symbol may be automatically generated. The generated user interface may support a variety of data types for notes, such as integer notes, real number notes, mandatory notes, arbitrary notes, controlled notes, and partially-controlled notes.

### TECHNICAL FIELD

This description relates to techniques for developing and using custom drawing symbols in a computer-aided drawing system.

### BACKGROUND

A computer-aided drawing system may be used to build graphical models and drawings of mechanical parts. Such a computer-aided drawing system may be used in a computer-aided design (CAD), a computer-aided manufacturing (CAM), a computer-aided engineering (CAE), or a product lifecycle management (PLM) system. A computer-aided drawing system may include geometric shapes, symbols, and text in a graphical drawing or model. Often a set (or library) of symbols may be included with a computer-aided drawing system. Some computer-aided drawing systems provide a capability to add custom drawing symbols to the symbol library. The same custom drawing symbol may be used in many drawings or in many places in the same drawing.

### SUMMARY

In one general aspect, a user interface to permit a user to create a symbol instance for a received symbol having at least one associated note is automatically generated. The user interface is generated based on the data defining each note included in the received symbol.

Implementations may include one or more of the following features. For example, the generated user interface may display a default value for a note. The user interface may be generated based on the data type of each note included in the received symbol. When the data type of a note is an integer, the user interface only permits an integer between a pre-defined minimum value and pre-defined maximum value to be entered for the note. When the data type of a note is a real number, the user interface only permits a real number between a pre-defined minimum value and pre-defined maximum value to be entered for the note. When the data type of a note is mandatory, the user interface does not permit modification of the note. When the data type of a note is arbitrary, the user interface permits modification of the note. When the data type of a note is controlled, the user interface presents a set of pre-defined values and only permits selection of one of the pre-defined values for the note. When the data type of a note is partially-controlled, the user interface presents a set of pre-defined values and permits selection of one of the pre-defined values or entry of a value other than one of the pre-defined values for the note.

In another general aspect, a drawing symbol may be created by presenting a user interface for creating a symbol including an associated note, receiving data defining the associated note, storing the symbol and the data defining the associated note, creating a symbol instance including the note, receiving a value to be included in the note of the symbol instance, associating the symbol instance with a position on a particular drawing, and storing the symbol instance and the association of the symbol instance with the position on the particular drawing. Implementations may include one or more of the following features. The notes may be of different data types. Data types for a note may include integer, real number, mandatory, arbitrary, controlled, and partially-controlled.

All or a portion of the geometric shape associated with a symbol instance may be edited. Geometric aspects of the drawing symbol may be created using rich drawing features of the computer-aided drawing system. Permitted geometric features include, for example, lines, arcs, and splines. Other aspects of the geometry of the drawing symbol that may be controlled include line thickness, font, and color.

Implementations of the techniques discussed above may include a method or process, or computer software on a computer-accessible medium.

The details of one or more of the implementations are set forth in the accompanying drawings and description below. Other features and advantages will be apparent from the descriptions and drawings, and from the claims.

The ability to create a custom drawing symbol that adheres to an industry or company standard and may be used in many drawings or many times in a particular drawing may be beneficial. A computer-aided drawing system that has a capability to create a custom drawing symbol that includes geometric portions and different types of textual notes may improve the efficiency of creating and using custom drawing symbols.

A computer-aided drawing system that allows more than one note to be associated with a drawing symbol and different data types of notes to be created may increase the number of drawing symbols added to a drawing that meet a pre-defined drawing symbol standard. Increasing the number and types of notes that may be associated with a drawing symbol increases the likelihood that a symbol will be created such that a user of the computer-aided drawing system only needs to enter text relevant to a particular instance of a standardized symbol on a drawing.

A user interface for creating particular instances of a drawing symbol may be created by the computer-aided drawing system based on the data definition of the drawing symbol in a symbol library. This may reduce the labor required to add a custom drawing symbol to the symbol library and, thus, encourage the addition of standard drawing symbols to the library. Adherence to a pre-defined standard may increase if more standard drawing symbols are available in the symbol library.

The association of text with a geometric custom drawing symbol may allow the position of a symbol in a drawing to be changed more efficiently in that the geometric portion and textual portion of the custom drawing symbol may be moved together automatically. This may reduce the number of steps needed to move a symbol that includes both a geometric portion and one or more textual portions.

### DESCRIPTION OF THE DRAWINGS

FIG. 1 is a block diagram of a programmable system for developing and using a custom drawing symbol.

FIG. 2 is a block diagram illustrating a custom drawing symbol.

FIGS. 3 and 5 are flow charts of processes for creating a custom drawing symbol that is stored in a symbol library.

FIGS. 4 and 7 are flow charts illustrating processes for creating in a drawing an instance of a custom drawing symbol.

FIG. 6 is a flow chart of a process for generating a user interface to create an instance of a custom drawing symbol.

Like reference symbols in the various drawings indicate like elements.

### DETAILED DESCRIPTION

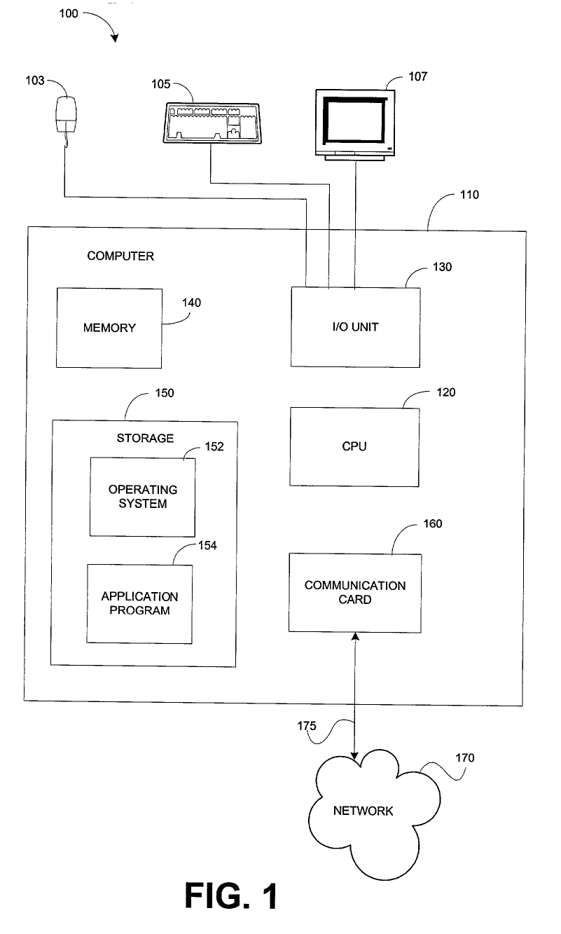

Referring to FIG. 1, a programmable system 100 for developing and using custom drawing symbols includes a variety of input/output (I/O) devices (e.g., mouse 103, keyboard 105, and display 107) and a computer 110 having a central processor unit (CPU) 120, an I/O unit 130, a memory 140, and a data storage device 150. Data storage device 150 may store machine-executable instructions, data, and various programs such as an operating system 152 and one or more application programs 154 for developing and using custom drawing symbols, all of which may be processed by CPU 120. Each computer program may be implemented in a high-level procedural or object-oriented programming language, or in assembly or machine language if desired; and in any case, the language may be a compiled or interpreted language. Data storage device 150 may be any form of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM).

System 100 also may include a communications card or device 160 (e.g., a modem and/or a network adapter) for exchanging data with a network 170 using a communications link 175 (e.g., a telephone line, a wireless network link, a wired network link, or a cable network). Other examples of system 100 may include a handheld device, a workstation, a server, a device, a component, other equipment, or some combination of these capable of responding to and executing instructions in a defined manner. Any of the foregoing may be supplemented by, or incorporated in, ASICs (application-specific integrated circuits).

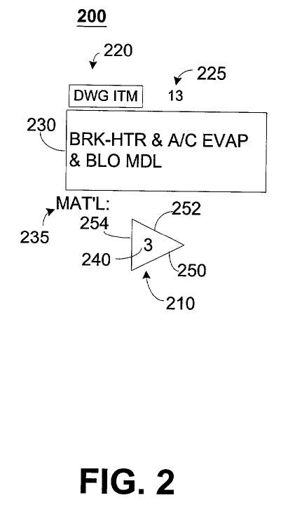

FIG. 2 shows a custom drawing symbol 200 that includes a geometric portion 210 and five notes 220, 225, 240, 235, and 240. The geometric portion 210 is a triangle created using three lines 250, 252, and 254. The text of notes 220 and 235 is mandatory text that cannot be changed from the text in the note associated with the custom drawing symbol. The text contained in notes 225, 230, and 240 is entered when an instance of the custom drawing symbol is created. The process of creating a particular instance of a custom drawing symbol stored in a symbol library may be referred to as instantiating a custom drawing symbol.

Note 220 “DWG ITM” serves as a title for the integer “13” in note 225. The integer in note 225 is entered when the custom drawing symbol is instantiated. Together note 220 and note 225 form a drawing item number title that uses a standard abbreviation “DWG ITM” for all instances of the particular custom drawing symbol and allows the drawing number itself 225 to be changed as each custom drawing symbol is instantiated. The value stored in note 225 may be generated automatically based on the number of prior instantiations of the custom drawing symbol in the drawings, or on the number of items previously included in the drawing. In some implementations, the value may be updated automatically as items in the drawing are edited, moved, or deleted. In other implementations, a user may enter the value stored in note 225.

Note 230 is an arbitrary note that describes the item to which the drawing item number refers. Note 230 is a note of up to two lines of text entered when the custom drawing symbol is instantiated.

Note 235 “MAT'L” serves as a title for the integer “3” in note 240, which is located in the interior of the triangle portion of the custom symbol. Together note 235 and note 240 form a material number that uses a standard abbreviation “MAT'L” for all instances of the particular custom drawing symbol and allows the integer of the material number 240 to be changed as each custom drawing symbol is instantiated. In some implementations, the value in note 240 may be selected from a predetermined table of values and corresponding material types.

The ability to define several notes and different data types for notes in the custom drawing symbol improves the ability of the computer-aided drawing system to create custom drawing symbols that adhere to a pre-defined standard. Here, the ability to define in the custom drawing symbol both a note that is not able to be changed from the drawing symbol in the library and a note that may be changed in the particular instance of the drawing symbol may increase the number of instantiated custom drawing symbols that adhere to a pre-defined symbol standard.

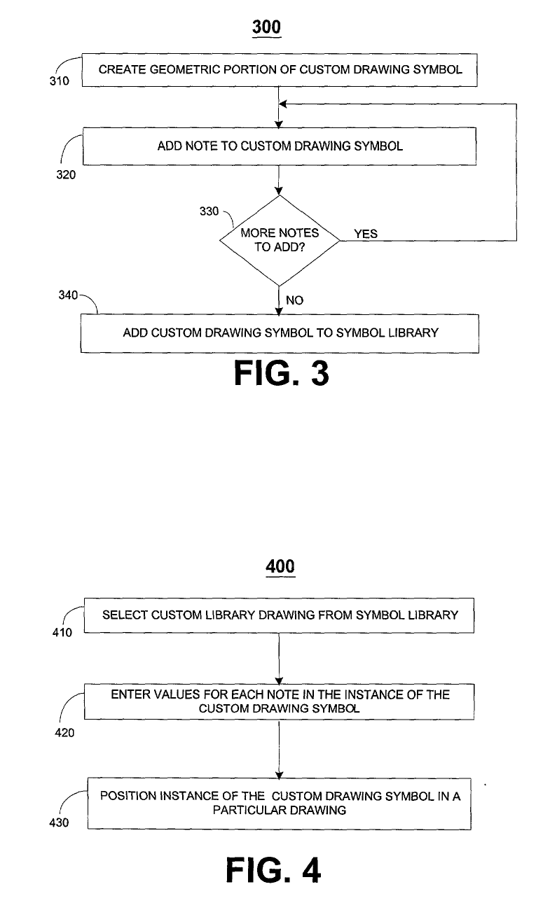

Referring to FIG. 3, a process 300 controls a processor to display a user interface that allows a user of the computer-aided drawing system to create a custom drawing symbol that is stored in a symbol library. The process 300 is initiated when a user of the computer-aided drawing system determines that a new symbol should be added to the symbol library for use in drawings. A symbol that is added to the symbol library may be referred to as a custom drawing symbol. A custom drawing symbol may or may not be a symbol that belongs to a pre-defined standard set of symbols.

The processor presents a user interface that allows a user to create a geometric portion of the custom drawing symbol (step 310) and to add one or more notes to the custom drawing symbol (step 320). The user interface allows a data type to be associated with each note in the custom drawing symbol. Data types may include a mandatory note, a controlled note, a partially-controlled note, an integer note, a real value note, and an arbitrary note.

A mandatory note is specified when the custom drawing symbol is created and added to the symbol library and may not be changed when an instance of the custom drawing symbol is created. Mandatory text must be the same for all instances of a custom drawing symbol. Mandatory notes are particularly useful for creating standard titles or labels in a drawing symbol.

A controlled note refers to a note that is limited to a pre-defined (or enumerated) set of text values. A default value for the controlled note may be specified within the custom drawing symbol. When an instance of the custom drawing symbol is created, the default value may be used or one of the other enumerated values may be selected.

Like a controlled note, a partially-controlled note is provided with an enumerated set of text values for which a default value may be set. However, when a particular instance of the custom drawing symbol is created, a text value that is not enumerated may be specified in the custom drawing symbol.

An integer note refers to a note that must be an integer. A permitted range and a default value for the integer may be specified.

A real value note refers to a note that must be a real number. An allowable range and default value for the numeral may be specified.

An arbitrary note refers to text that may be specified in the instance of the custom drawing symbol and may be specified differently for each instance of the custom drawing symbol. Arbitrary text may be one or more lines of text. A default value for arbitrary text may be specified in the custom drawing symbol and presented each time the custom drawing symbol is instantiated. In general, the only limitations placed upon an arbitrary note are the location of the note relative to the symbol, and, optionally, a default value.

When the adding of notes is complete (step 330), the processor adds the custom drawing symbol to the symbol library (step 340).

Referring to FIG. 4, a process 400 controls a processor to display a user interface that allows a user of the computer-aided drawing system to create from a custom drawing symbol an instance that is associated with a particular drawing. The process 400 controls a processor to provide a user interface that allows a user of the computer-aided drawing system to create in a drawing an instance of a custom drawing symbol stored in the symbol library. The processor presents a user interface that allows a user to select a particular custom drawing symbol from the symbol library (step 410). Then the processor configures a user interface to allow a user to specify values for each note in the instance of the custom drawing symbol (step 420). Finally, the instance of the custom drawing symbol is positioned on a particular drawing (step 430).

Typically, the person who uses process 300 to create and store a custom drawing symbol in the symbol library may be referred to as a symbol librarian. Users other than the symbol librarian typically use the process 400 to create an instance of a custom drawing symbol in a particular drawing.

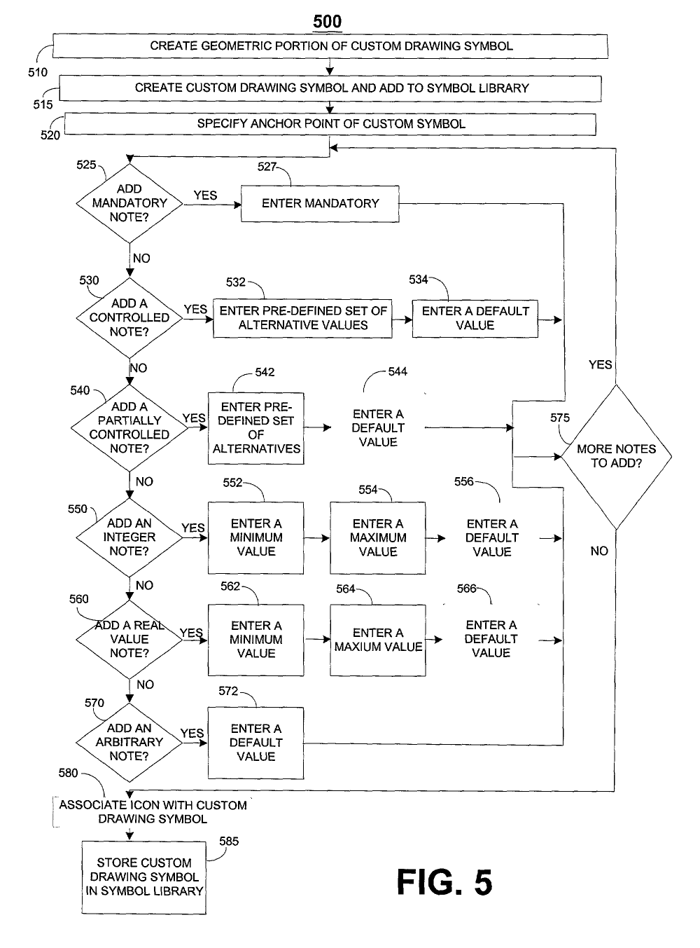

FIG. 5 illustrates a process 500 that is a more specific example of a process for creating a custom drawing symbol. In a typical implementation, a drawing tool is used to create the geometric portion of the custom drawing symbol (step 510). For instance, three lines may be used to form a triangle that is used as the geometric portion of the custom drawing symbol which was described with respect to FIG. 2. The processor then presents a user interface that allows the user to create a custom drawing symbol that includes the geometric portion and to add the custom drawing symbol to the symbol library (step 515).

The user may add a custom drawing symbol to the symbol library by specifying a position for the new custom drawing symbol in a hierarchical list of custom drawing symbols contained in the symbol library. The list may employ a tree paradigm in which custom symbols are stored in libraries of related symbols. The interface may allow the user to drag and drop entries in list, and to otherwise reorder the list. When adding the custom drawing symbol to the symbol library, the user also may specify a symbol title and document file name in which the geometric portion of the symbol is stored.

The user interface allows the user to specify an anchor point of the geometric portion of the custom drawing symbol (step 520). An anchor point identifies the point on or near the geometric portion of the custom symbol that is to be used as a reference point to locate the position at which an instance of the custom symbol is placed in a particular drawing. For example, the anchor point may be located at the end of a line extending from the geometric portion of the custom drawing symbol. The anchor point also may be associated with another object in the drawing.

The user interface also permits the user to add one or more notes to the custom drawing symbol (steps 525-575). In particular, the user interface allows the user to identify various types of notes to be used in a custom drawing symbol. For example, to add a mandatory note to the custom drawing symbol (step 525), the user enters the mandatory text to be included in the note (step 527).

To add a controlled note to the custom drawing symbol (step 530), the user enters the pre-defined set of text alternative values (step 532) and, optionally, a default value from the pre-defined set (step 534). Text alternative values may be any type of data, including characters, integers, and real numbers.

To add a partially-controlled note to the custom drawing symbol (step 540), the user enters a pre-defined set of text alternative values (step 542) and, optionally, a default value from the pre-defined set (step 544). As with a controlled note, the text alternative values may be any type of data, including characters, integers, and real numbers.

To add an integer note (step 550), the user enters a range of permitted values by entering a minimum value and a maximum value (steps 552-554). The user also may enter a default value (step 556).

Similarly, to add a real value note (step 560), the user enters a minimum value and a maximum value (steps 562-564) to identify the range of permitted values. The user also may enter a default value (step 566).

To add an arbitrary note (step 570) to the custom drawing symbol, the user may enter a default value (step 572). The default value may be left blank so that the arbitrary note just designates a position at which a note may be added.

When all notes have been added to the custom drawing symbol (step 575), the processor displays a user interface that permits the user to associate an icon with the custom drawing symbol (step 580). An associated icon may be used to select the custom drawing symbol from the symbol library when an instance of the custom drawing symbol is to be created.

The processor configures a user interface to allow a user to store a custom drawing symbol in the symbol library (step 585). When the custom drawing symbol has been stored in the symbol library, the custom drawing symbol is available to create an instance of the custom drawing symbol in a particular drawing.

A geometric portion of the symbol is not required—that is, a symbol may include only one or more notes.

In other implementations, both a geometric portion and a text portion of the custom drawing symbol may be created in the drawing tool rather than only the geometric portion. When defining notes (steps 525-575), the processor creates a user interface that permits the data type and attributes associated with the data type to be specified for each note entered using the drawing tool.

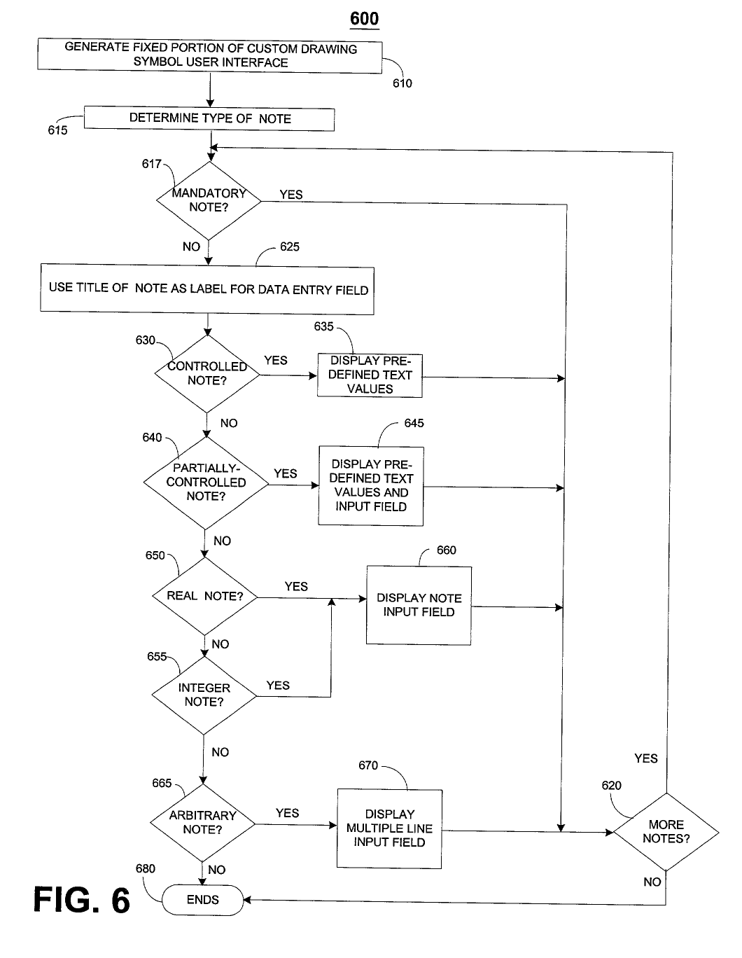

Referring to FIG. 6, a process 600 involves generating a user interface to create an instance of a particular custom drawing symbol. The processor generates the fixed portion of the custom drawing symbol user interface (step 610). The fixed portion of the user interface is the same regardless of which custom drawing symbol is to be instantiated. For example, the fixed portion of the user interface in one implementation includes an indication of the source of the text setting preferences (e.g., color and font) to be used in the custom drawing symbol being instantiated. The text settings that are specified in the symbol library for the custom drawing symbol may be used. Alternatively, the text settings that are specified in the drawing in which the custom drawing symbol is being instantiated may be used. The fixed portion of the user interface also may include information about the size of the symbol (such as a scale value that identifies a relative measure of symbol size). Other implementations may present additional or alternative information in the fixed portion of the user interface.

The processor then proceeds to create the user interface for creating an instance of a particular custom drawing symbol based on the number and type of notes in the custom drawing symbol (steps 615-670). For each note, the processor starts by determining the type of note (step 615).

If the processor determines that the note is a mandatory note (step 617), nothing about the note needs to be displayed in the user interface, and the processor determines whether additional notes are included in the custom drawing symbol (step 620). If so, the processor determines the type of note for the next note (step 615). In general, mandatory notes do not appear in the user interface used to instantiate a library symbol. However, since mandatory notes appear as notes in the instance of the custom drawing symbol after the symbol has been created, some implementations may display mandatory notes in the user interface when an instance of a custom drawing symbol is being created.

If the processor determines that the note is not a mandatory note (step 617), the processor uses the title of the note as a label for the data entry field (step 620). The processor then creates the appropriate text input field based on the type of note and the values associated with the note in the custom drawing symbol (steps 630-670).

In particular, if the processor determines that the note is a controlled note (step 630), the processor displays a list of the pre-defined text values from which the user is to select (step 635). If a default value is indicated in the custom drawing symbol, the default value may be highlighted in the list of pre-defined text values or positioned at the top of the list.

If the processor determines that the note is a partially-controlled note (step 640), the processor displays a list of the pre-defined text values from which the user is to select and a text input field in which a text value that is not one of the enumerated values may be entered (step 645). If a default value is indicated in the custom drawing symbol, the default value may be indicated in the list of pre-defined text values.

If the processor determines that the note is a real number note (step 650) or an integer note (step 655), the processor displays a note input field that requires entry of an appropriate numerical value in the permitted range. When a default value has been designated, the note input field is populated with that value.

If the processor determines that the note is an arbitrary note (step 665), the processor displays a multiple line text input field (step 670). In some implementations, the processor may distinguish between single and multiple line arbitrary text and display alternative text input fields based on that distinction.

If the processor determines that the custom drawing symbol includes additional notes (step 675), the processor determines the type of note (step 615) and proceeds as discussed previously. When the required data input fields for all of the notes in the custom drawing symbol have been generated (step 620), the processor ends the process (step 680).

In general, the user interface is generated such that the notes are presented in the order in which they were added when creating the custom drawing symbol. However, the system permits the user who creates the custom drawing symbol to use drag and drop and other techniques to rearrange the order in which notes are presented.

A processor may perform process 600 when a particular instance of a custom drawing symbol is being created. Alternatively, a processor may perform process 600 to generate a user interface, and then may store the user interface created for use at a later time.

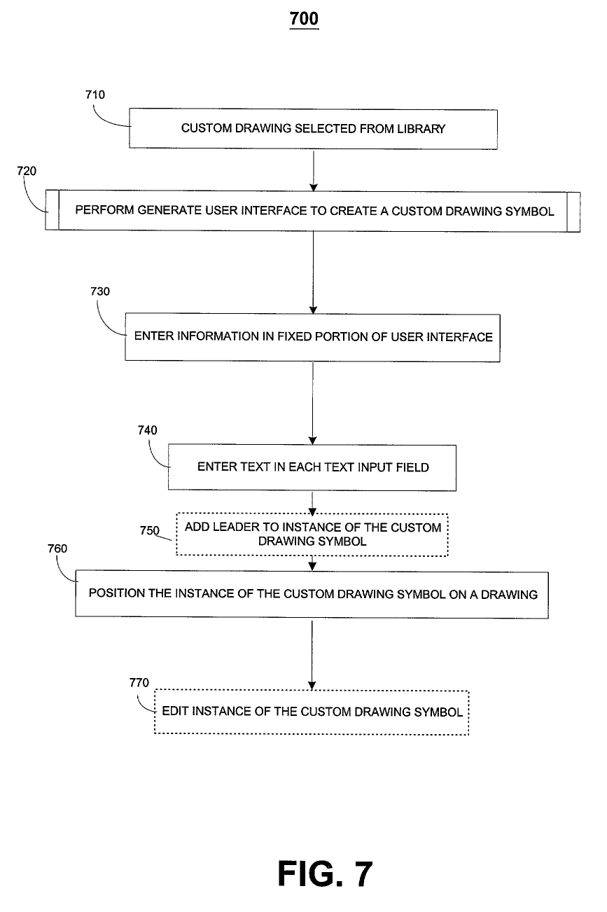

FIG. 7 illustrates a process 700 that is a more specific example of a process performed by a processor to create an instance of a custom drawing symbol. The process 700 is initiated when a user selects a custom drawing symbol from the symbol library (step 710). The processor then generates a user interface to create the instance of the custom drawing symbol (step 720). For example, the processor may do so using the process 600 described above with respect to FIG. 6 (step 720).

The processor then permits the user to use the generated user interface to enter information into the fixed portion of the user interface (step 730). This may include such information as text setting preferences to use for the instance of the custom drawing symbol and a relative measure of the symbol size (scale setting). For example, text setting preferences may include font, character height, a space factor that indicates the relative spacing between letters, a line space factor that indicates the relative vertical spacing between lines of text, an aspect ratio that allows for shape distortion of characters, and a weight that indicates whether the text should be thin, normal, or thick.

The processor then permits the user to use the user interface to enter one or more notes as required by entering text in each text input field for integer notes, real value notes, partially-controlled notes, or arbitrary notes, or by selecting note value alternatives for controlled notes or partially-controlled notes in accordance with the note types described previously with respect to FIGS. 3-6 (step 740).

The processor also may permit the user to add one or more leaders to the instance of the custom drawing symbol (step 750). A leader may be a line, arrow, or arc that points from the symbol to another drawing object.

The user may place the instance of the custom drawing symbol on a drawing (step 760) using the generated user interface. Typically, an instance of a custom drawing symbol is placed on a drawing in association with another drafting object on the drawing. Alternatively, an instance of a custom drawing symbol may be placed in a drawing based on a fixed offset from a drawing object, relative to a view in a drawing, by a vertical text alignment method, a horizontal text alignment method, or in relation to a specific point in the drawing (such as a point in an edge of an object, an end point in a object, or an intersection point in a drawing).

The processor, however, will not allow an instance of a custom drawing symbol to be placed on a drawing if the entered value for an integer note or a real value note is outside the permitted range. In another implementation, however, a custom drawing symbol may be placed even when the entered values for integer or real value notes are outside the permitted range.

Additionally or alternatively, the processor may ensure that integer or real values are within the permitted range of the custom drawing symbol when a value is entered in the text input field.

When an instance of a custom drawing symbol has been added to a drawing, the instance may be edited (step 770). Any of the values present when the custom drawing symbol was created may be changed. Additionally, the color, line font, line height, line spacing, and line width of curves and lines in the geometric portion or any shape that makes up the geometric portion of may be edited. For instance, the triangle 210 or the lines 250, 252, and 254 making up the triangle as described with reference to FIG. 2 may be edited to modify the color, line font, line height, line spacing, and line width.

Additionally or alternatively, the processor may present a note or notes associated with an instance of a custom drawing symbol in a language other than English if the font types needed to display the text are available. For instance, a custom symbol may contain a note containing text in Japanese Kanjii.

The benefits from creating a custom symbol that includes more than one note and different data types of notes are not limited to creating symbols that adhere to a pre-defined standard. These techniques may be useful generally to improve the efficiency of creating and using custom symbols.

The techniques for creating a custom symbol that includes more than one note and different data types of notes have been described relative to a particular implementation using mandatory, controlled, partially-controlled, integer, real value and arbitrary note data types. The benefits of the techniques for developing and using custom symbols are not limited to those data types. These techniques are equally applicable to other data types.

The benefits from creating a custom symbol using the techniques described are not limited to instantiating a custom symbol stored in a symbol library and are equally applicable to other contexts. For example, these techniques may be used when copying a custom symbol from one drawing to create the same or similar custom symbol in another drawing, or when copying a custom symbol from one position in a drawing to create the same or similar custom symbol in a different position in the same drawing.

Implementations may include a method or process, an apparatus or system, or computer software on a computer medium. It will be understood that various modifications may be made without departing from the spirit and scope of the following claims. For example, advantageous results still could be achieved if steps of the disclosed techniques were performed in a different order and/or if components in the disclosed systems were combined in a different manner and/or replaced or supplemented by other components.

What is claimed is:

1. A computer-implemented method for creating a user interface for a drawing system, the method comprising:
receiving a symbol with at least one associated note,
receiving data defining each note included in the received symbol, and
automatically generating a symbol instance user interface to permit a user to create a symbol instance, the symbol instance user interface being generated based on the data defining each note.

2. The method of claim 1 wherein automatically generating a symbol instance user interface comprises automatically generating a symbol instance user interface that displays a default value for a note.

3. The method of claim 1 further comprising determining a data type of each note included in the received symbol, wherein automatically generating a symbol instance user interface comprises automatically generating a symbol instance user interface based on the data type of each note included in the received symbol.

4. The method of claim 3 wherein:
the data type of a note comprises an integer, and
automatically generating a symbol instance user interface comprises automatically generating a symbol instance user interface that only permits an integer between a pre-defined minimum value and a pre-defined maximum value to be entered for the note having the integer data type.

5. The method of claim 3 wherein:
the data type of a note comprises a real number, and
automatically generating a symbol instance user interface comprises automatically generating a symbol instance user interface that only permits a real number between a pre-defined minimum value and a pre-defined maximum value to be entered for the note having the real number data type.

6. The method of claim 3 wherein:
the data type of a note comprises a mandatory note, and
automatically generating a symbol instance user interface comprises automatically generating a symbol instance user interface that does not permit modification of the note having the mandatory note data type.

7. The method of claim 3 wherein:
the data type of a note comprises an arbitrary note, and
automatically generating a symbol instance user interface comprises automatically generating a symbol instance user interface that permits modification of the note having the arbitrary data type.

8. The method of claim 3 wherein:
the data type of a note comprises a controlled note, and
generating a symbol instance user interface comprises generating a symbol instance user interface that presents a set of pre-defined values and only permits selection of one of the pre-defined values for the note having the controlled data type.

9. The method of claim 3 wherein:
the data type of a note comprises a partially-controlled note, and
generating a symbol instance user interface comprises generating a symbol instance user interface that presents a set of pre-defined values, permits selection of one of the pre-defined values for the partially-controlled note, and permits entry of a value other than one of the pre-defined values for the note having the partially-controlled data type.

10. The method of claim 3 further comprising determining whether each note included in the received symbol may be modified in the symbol instance, wherein automatically generating a symbol instance user interface comprises automatically generating a symbol instance user interface that only permits modification of notes that may be modified in the symbol instance.

11. A method for creating a drawing symbol for use in a drawing system, the method comprising:
presenting a user interface for creating a symbol including at least one associated note,
receiving data defining a first note to be included in the symbol,
storing the symbol and the data defining the first note,
creating a symbol instance including the first note,
receiving a first value to be included in the first note of the symbol instance,
associating the symbol instance with a position on a particular drawing, and
storing the symbol instance and the association of the symbol instance with the position on the particular drawing.

12. The method of claim 11 further comprising:
receiving data defining a second note to be included in the symbol,
storing the data defining the second note with the symbol,
including the second note when creating the symbol instance, and
receiving a second value to be included in the second note of the symbol instance.

13. The method of claim 12 wherein:
receiving data defining a first note and a second note to be included in the symbol comprises receiving data defining a first note of a first data type and a second note of a second data type to be included in the symbol, and
the first data type is different from the second data type.

14. The method of claim 13 wherein when the first data type comprises an integer data type, receiving the first value comprises requiring the first value to be an integer between a pre-defined minimum value and pre-defined maximum value.

15. The method of claim 13 wherein when the first data type comprises a real number data type, receiving the first value comprises requiring the first value to be a real number between a pre-defined minimum value and pre-defined maximum value.

16. The method of claim 13 wherein when the first data type comprises a mandatory note data type, receiving the first value comprises requiring the first value to be the same as a value defined in the received data defining the first note.

17. The method of claim 13 wherein when the first data type comprises a controlled note data type, receiving the first value comprises requiring the first value to be one of a set of pre-defined values.

18. The method of claim 12 further comprising modifying a portion of a geometric shape associated with the symbol instance.

19. A computer-readable medium or propagated signal embodied thereon a computer program configured to create a user interface for a drawing system, the medium comprising a code segment configured to:
receive a symbol with at least one associated note,
receive data defining each note included in the received symbol, and
automatically generate a symbol instance user interface to permit a user to create a symbol instance, the symbol instance user interface being generated based on the data defining each note.

20. The medium of claim 19 wherein automatically generating a symbol instance user interface comprises automatically generating a symbol instance user interface that displays a default value for a note.

21. The medium of claim 19 further comprising a code segment configured to determine a data type of each note included in the received symbol, wherein automatically generating a symbol instance user interface comprises automatically generating a symbol instance user interface based on the data type of each note included in the received symbol.

22. The medium of claim 21 wherein:
the data type of a note comprises an integer, and
automatically generating a symbol instance user interface comprises automatically generating a symbol instance user interface that only permits an integer between a pre-defined minimum value and a pre-defined maximum value to be entered for the note having the integer data type.

23. The medium of claim 21 wherein:
the data type of a note comprises a real number, and
automatically generating a symbol instance user interface comprises automatically generating a symbol instance user interface that only permits a real number between a pre-defined minimum value and a pre-defined maximum value to be entered for the note having the real number data type.

24. The medium of claim 21 wherein:
the data type of a note comprises a mandatory note, and
automatically generating a symbol instance user interface comprises automatically generating a symbol instance user interface that does not permit modification of the note having the mandatory note data type.

25. The medium of claim 21 wherein:
the data type of a note comprises an arbitrary note, and
automatically generating a symbol instance user interface comprises automatically generating a symbol instance user interface that permits modification of the note having the arbitrary data type.

26. The medium of claim 21 wherein:
the data type of a note comprises a controlled note, and
generating a symbol instance user interface comprises generating a symbol instance user interface that presents a set of pre-defined values and only permits selection of one of the pre-defined values for the note having the controlled data type.

27. The medium of claim 21 wherein:
the data type of a note comprises a partially-controlled note, and
generating a symbol instance user interface comprises generating a symbol instance user interface that presents a set of pre-defined values, permits selection of one of the pre-defined values for the partially-controlled note, and permits entry of a value other than one of the pre-defined values for the note having the partially-controlled data type.

28. The medium of claim 21 further comprising a code segment configured to determine whether each note included in the received symbol may be modified in the symbol instance, wherein automatically generating a symbol instance user interface comprises automatically generating a symbol instance user interface that only permits modification of notes that may be modified in the symbol instance.

29. A computer-readable medium or propagated signal having embodied thereon a computer program configured to create a drawing symbol for use in a drawing system, the medium comprising code segments configured to:
present a user interface for creating a symbol including at least one associated note,
receive data defining a first note to be included in the symbol,
store the symbol and the data defining the first note,
create a symbol instance including the first note,
receive a first value to be included in the first note of the symbol instance,
associate the symbol instance with a position on a particular drawing, and
store the symbol instance and the association of the symbol instance with the position on the particular drawing.

30. The medium of claim 29 further comprising code segments configured to:
receive data defining a second note to be included in the symbol,
store the data defining the second note with the symbol,
include the second note when creating the symbol instance, and
receive a second value to be included in the second note of the symbol instance.

31. The medium of claim 30 further comprising a code segment configured to receive data defining a first note of a first data type and a second note of a second data type to be included in the symbol, wherein the first data type is different from the second data type.

32. The medium of claim 31 further comprising a code segment configured to, when the first data type comprises an integer data type, require the first value to be an integer between a pre-defined minimum value and pre-defined maximum value.

33. The medium of claim 31 further comprising a code segment configured to, when the first data type comprises a real number data type, require the first value to be a real number between a pre-defined minimum value and pre-defined maximum value.

34. The medium of claim 31 further comprising a code segment configured to, when the first data type comprises a mandatory note data type, require the first value to be the same as a value defined in the received data defining the first note.

35. The medium of claim 31 further comprising a code segment configured to, when the first data type comprises a controlled note data type, require the first value to be one of a set of pre-defined values.

36. The medium of claim 30 further comprising a code segment configured to permit modification of a portion of a geometric shape associated with the symbol instance.
